(19) United States
(12) Patent Application Publication
(10) Pub. No.: US 2008/0098978 A1
(43) Pub. Date: May 1, 2008

(54) INTERNAL SUPPORT STRUCTURE FOR AN INTERNAL COMBUSTION ENGINE

(76) Inventor: Timothy D. Oelerich, West Bend, WI (US)

Correspondence Address: JOHN K. MCCORMICK, 6781 GLACIER DRIVE, WEST BEND, WI, 53090, US

(21) Appl. No.: 11/554,898

(22) Filed: Oct. 31, 2006

(51) Int. Cl. F02F 7/00; F01B 1/00; F16C 9/02

(52) U.S. Cl. 123/195 H; 384/294; 92/147

(57) ABSTRACT

A reinforcement plate for a reciprocating engine that greatly reduces the elastic and plastic deformation of engine block components when the engine is run at high rpm and force is provided which reduces structural fatigue thereby increasing available horsepower. The one piece reinforcement plate ties together the main bearing caps to each other and to the engine block skirt, thereby increasing the rigidity of the main bearing caps and reducing the vibration of the engine. Crankshaft counterweight and crankshaft throw clearance openings, as well as other clearance areas, are provided in the reinforcement plate.

### BACKGROUND OF THE INVENTION

In the area of big block and other high performance gasoline motors such as those utilized in automobile racing, boats and other applications, the participating individuals or teams often design the engines to their own specifications. In many instances, these designs are kept highly classified and secret from others in order to provide the individual or racing team with a competitive advantage. In other cases, an individual may desire to improve the performance of their engine by modifying the engine to provide greater horsepower than the engine was originally designed for.

In automobile racing, for example, the engines are modified to the point that some do not even last through a specific race. These engines are typically modified to the structural limits of the design and materials in use. During actual running of the engines, they are run at their highest or near highest RPM (revolutions per minute) in order to generate the greatest horsepower available for a substantial period of time.

During this time, the engine components experience an extremely high level of force, torque and stress placed on all of the components of the engine. Some of the components experiencing the high levels of stress include the crankshaft, crankshaft bearings, crankshaft bearing caps and the engine block to which the crankshaft is mounted. The crankshaft bearing surfaces, bearings, caps and a portion of the block that is designed to hold the crankshaft are cylindrical in nature to provide for a smooth surface for the crankshaft to rotate in. However, in use at high RPM and high pressure and torque, the crankshaft bearings, caps and related engine block mating surfaces actually deform elastically into an egg shaped oval.

This condition can cause a loss of available power as well as failure of the engine if the deformation of the caps and engine block is too great, thereby creating a catastrophic failure of the engine and potential injury to the user and/or bystanders.

The present invention responds to these problems by providing a reinforcement plate configured for attachment across the main bearing caps of a reciprocating internal combustion engine and to the engine block skirt on the lower portion of the engine block, thereby serving to tie the bearing caps more rigidly to each other as well as to the engine block skirt. This reduction of relative movement between the main bearing caps in the engine greatly improves the alignment of the bearings during operation and improves the overall operating efficiency of the engine.

A discussion of the related art of which the present inventor is aware, and their differences and distinctions from the present invention are provided below.

As an aid in preventing this deformation as well as other stresses and movements within the engine as a whole, there has been developed and is on the market a variety of devices generically called bearing cap “girdles”. One such girdle is disclosed in U.S. Pat. No. 6,928,974 issued on Aug. 16, 2005 to Markou which describes a flat planar reinforcement plate that attaches across the main bearing caps and has clearance between the outer edges of the flat plate and the inside walls of the engine skirt to allow for the oil to drain back into the oil pan. Any connection to the lower engine skirt is accomplished, if at all, with a bolt going through the lower engine skirt into the main bearing cap itself.

U.S. Pat. No. 3,046,954 issued on Jul. 31, 1962 to Carl S. Hoffman et al., describes numerous embodiments of bearing cap girdles. The majority of the embodiments comprise multiple component links stamped of relatively thin material which tie only two adjacent bearing caps together along one side of the engine rather than spanning all of the bearing caps simultaneously. One embodiment discloses an elongated stamped component that is secured along each side of the engine but not to the lower engine block skirt, however this still requires two separate components rather than a single unitary plate of the present invention. In a further embodiment, Hoffman provides a single plate which is bolted to all of the main bearing caps directly beneath the crankshaft, but this plate does not use the main bearing cap bolts to anchor it to the bearing caps. Rather, a series of smaller bolts are utilized to secure the plate to the bearing caps thereby obviating most of the advantage of spanning all of the bearing caps with a unitary plate. Furthermore, the plate is not secured to the lower engine block skirt.

U.S. Pat. No. 4,465,041 issued on Aug. 14, 1984 to Yoshimasa Hayashi describes the integral installation of a ferrous reinforcement in the lower portion of a light metal alloy engine block. While Hayashi describes the use of ferrous metal, the metal he describes are relatively low strength, i.e. cast iron or mild steel. Also, the Hayashi reinforcement must be accomplished at the time the engine block is cast as the reinforcement is an integral part of the engine block. Furthermore, as the reinforcement is integrated with the block, it cannot serve to tie the main bearing caps together after the block has been cast.

U.S. Pat No. 4,876,998 issued on Oct. 31, 1989 to Peter Wunsche describes a specially formed engine block and oil pan wherein the oil pan includes longitudinal stiffeners in the oil pan. The pan is bolted to the bottom of the engine block in an inwardly extending bolt pattern, as opposed to the conventional peripheral pattern. While the Wunsche oil pan may provide additional stiffness to the engine block, it does not attach to the main bearing caps as does the present invention.

U.S. Pat. Publication No. 2006/0081210 published on Apr. 20, 2006 to Kunitoshi Kajiwara et al., disclosed a plurality of bearing cap beams and bolts fixing the bearing cap beams to the skirt portion of the engine block and the bearing cap beams and bearing cap are fixed to the cylinder block by two or more bolts. A further embodiment includes baffles that are attached between the bearing cap beams, however, both embodiments still require multiple beam components rather than a single unitary construction.

None of the above inventions and patents, either singly or in combination, is seen to describe the instant invention as claimed. Therefore a reinforcing plate for an internal combustion engine that solves the aforementioned problems is desired.

### OBJECTS AND SUMMARY OF THE INVENTION

It is an object of the present invention to provide a structure for strengthening and stabilizing a crankshaft in a multi-cylinder internal combustion engine which improves upon the aforementioned limitations or problems encountered with the prior art while simultaneously increasing usable power output.

Another object of the present invention is to provide a main bearing cap and crankshaft supporting structure for a multi-cylinder engine which ties together the main bearing caps and the engine skirt with a one piece hardened steel plate in order to stabilize and minimize the vibration and elastic deformation of the crankshaft and main bearing caps when the engine is used in a high power output mode.

According to the present invention, there is provided a one piece high strength steel plate with sufficient opening for the crankshaft throws and counterweights to rotate through without interference, openings for the oil pump shaft and bolts and openings to accept new oil pan studs and main bearing cap studs. The main bearing cap studs being utilized to interconnect the engine block to the main bearing caps which are connected to a spacer washer which is then connected to the reinforcement plate of the present invention, all of which is tied together with the lock washers and jam nuts. This arrangement thereby ties 4 of the 5 of the main bearings caps together with a solid structure. The oil pan studs are then used to tie the reinforcement plate to the skirt with lock nuts in the counter bored holes of the reinforcement plate. This arrangement further stabilizes and reinforces the main bearing caps by tying the main bearing caps to the engine skirt through the use of the reinforcement plate. The oil pan is then attached to the oil pan studs with serrated flange nuts.

With the structure thus constituted in accordance with the present invention, as the engine skirt is directly secured to the reinforcement plate, which is also directly secured to the main bearing caps, the flexure, vibration and elastic deformation normally encountered in the crankshaft and main bearing caps is significantly reduced by the rigidity of the new structure. Furthermore, as the engine skirt is directly tied to the reinforcement plate, undesirable vibrations of each of the engine skirt portions are effectively suppressed.

The above and other objects, features and advantages of the present invention will become apparent from the following detailed description which is to read in conjunction with the appended drawings.

### BRIEF DESCRIPTION OF THE DRAWINGS

FIG. 1 is a prior art cross-sectional planar end view of a reciprocating engine.

FIG. 2 is an exploded rear bottom perspective view of the lower portion of a reciprocating engine depicting the placement of the reinforcement plate of the present invention.

FIG. 3 is a top planar view of the reinforcement plate of the present invention.

FIG. 4 is an exploded rear bottom perspective view of the lower portion of a reciprocating engine depicting the placement of the oil pan and main bearing studs.

FIG. 5 is a cross-sectional planar end view depicting the distance between the bottom of the reinforcement plate of the present invention and the lower mounting surface for the main bearing cap.

FIG. 6 is a front planar view of a prior art main bearing cap.

FIG. 7 is a front cross-section view of a reciprocating engine depicting the reinforcement plate of the present invention installed on the engine.

FIG. 8 is a front cross-section view of a reciprocating engine depicting the reinforcement plate of the present invention installed on the engine with the engine crankshaft in place.

FIG. 9 is a rear bottom perspective view of the lower portion of a reciprocating engine depicting the reinforcement plate of the present invention as installed on the engine.

### DETAILED DESCRIPTION OF THE PREFERRED EMBODIMENTS

The present invention comprises a reinforcement plate, and associated fasteners, for the lower end (or crankshaft location) of a reciprocating engine block. The present invention fastens to four (4) of the five (5) main bearing caps, thereby stiffening the main bearing caps, and to the lower engine block skirt between the engine block skirt and the oil pan, thereby further immobilizing the main bearing caps relative to the lower engine block and restricting the movement which would otherwise occur when the engine is in operation. The result is a substantially increased rigidity to the engine block and main bearing caps along with greater resistance to any elastic deformation of the main bearing caps and main bearings.

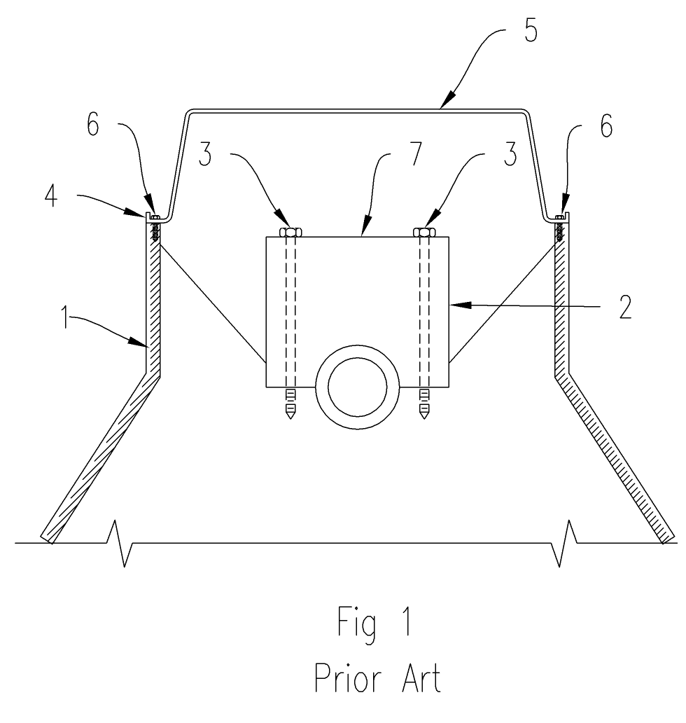

FIG. 1 depicts a prior art cross-sectional end view of a Ford FE engine block 1 with a main bearing cap 2 and an oil pan 5. The main bearing caps 2 are attached to the engine block 1 with bolts 3. The main bearing cap top surface 7 is in a close, but not exact, planar relationship with the lower surface of the engine block skirt 4, to which the oil pan 5 is attached with bolts 6.

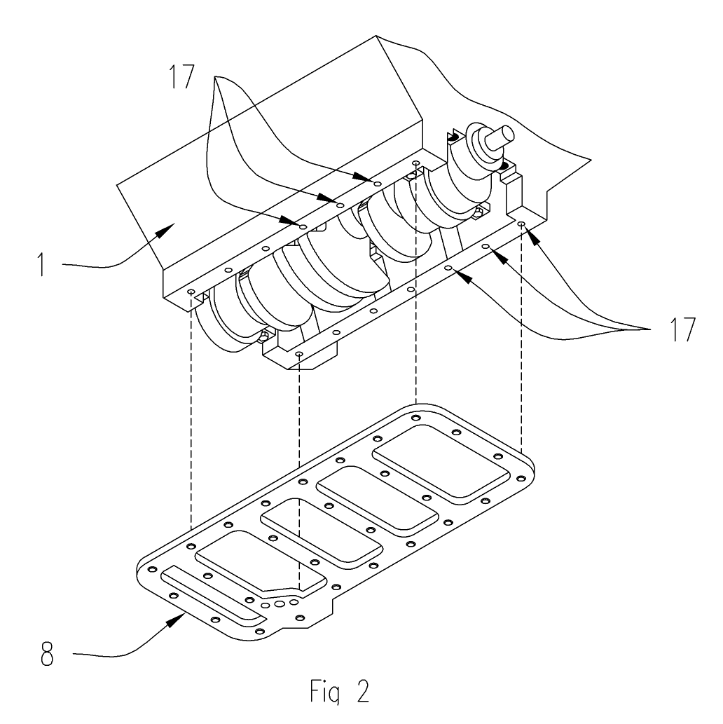

FIG. 2 is a rear bottom exploded perspective view of the present plate 8 separated from the bottom end of a conventional reciprocating engine block 1. The engine block 1 may be of any conventional configuration, however the present plate 8 is particularly adapted for installation in the Ford FE engine series used in Fords, Mercury's and Lincoln's from 1960 through 1970, which were available in 352, 360, 390, 410, 427 and 428 cubic inch displacement (c.i.d.) engines, as the top surface of the main bearing caps 7 is in a close planar relationship to the lower surface of the engine block skirt 4.

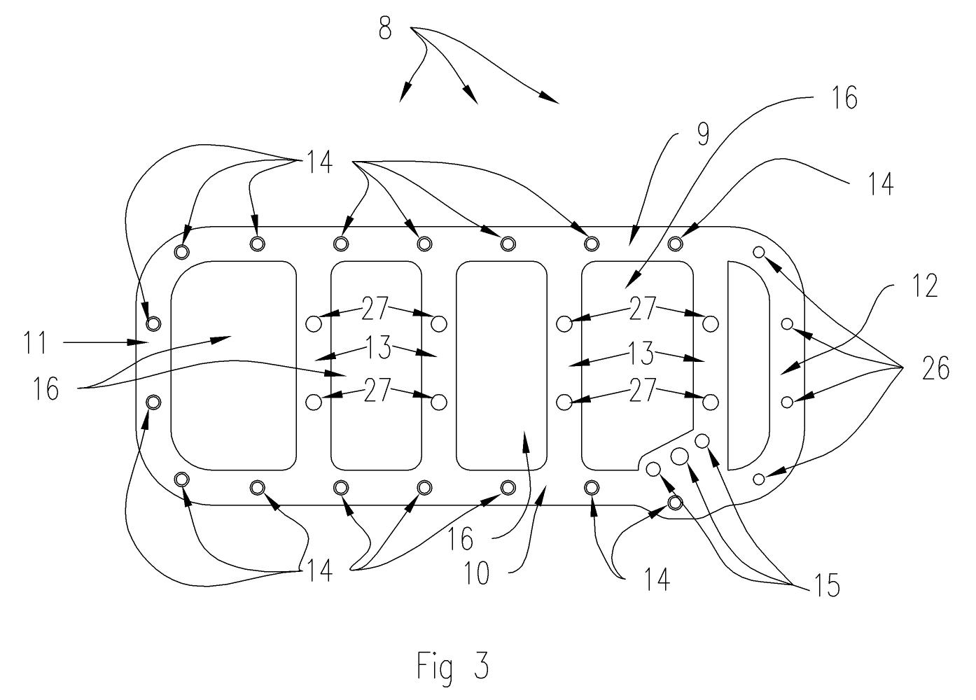

FIG. 3 is a top planar view of the reinforcement plate 8. The reinforcement plate 8 includes mutually opposed side members, 9 and 10 respectively, and mutually opposed end members, 11 and 12 respectively. A series of cross members or support ribs 13 spans the area between the side members 9 and 10 with the cross members 13 aligned across the main bearing caps 2 of the engine block 1 to allow for attachment thereto.

A series of counter-bored holes 14 are positioned in the side members 9 and 10 and the end member 11, said holes being aligned with the oil pan mounting holes in the engine block skirt. The cross members 13 each have two (2) straight through holes 27 that are aligned to the main bearing cap mounting holes of the #1 through #4 main bearing caps. The end member 12 has four (4) straight holes 26 which are utilized to bolt the reinforcement plate 8 to the timing cover (not shown). Additional holes 15 are provided for the oil pump.

The side members 9 and 10, end member 11 and cross members 13 defines a series of crankshaft counterweight and throw passages 16 therebetween to allow the offset crankshaft throws and their associated counterweights to rotate through the passages 16 without interference with the reinforcement plate 8. The crankshaft counterweight and throw passages 16 preferably have a generally rectangular shape in order to provide the necessary clearance, but also include a smoothly rounded radius at each of the internal corners for stress relief purposes.

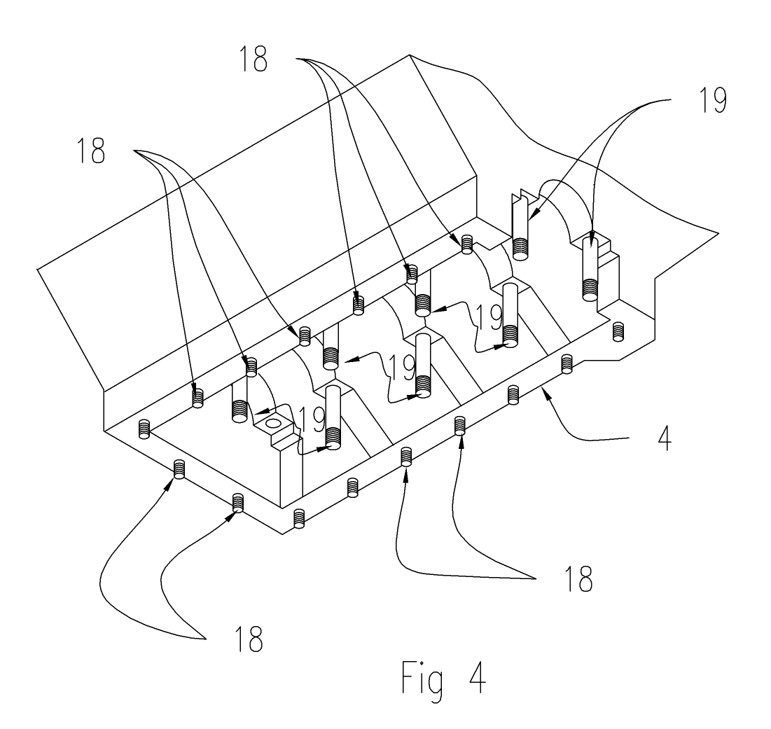

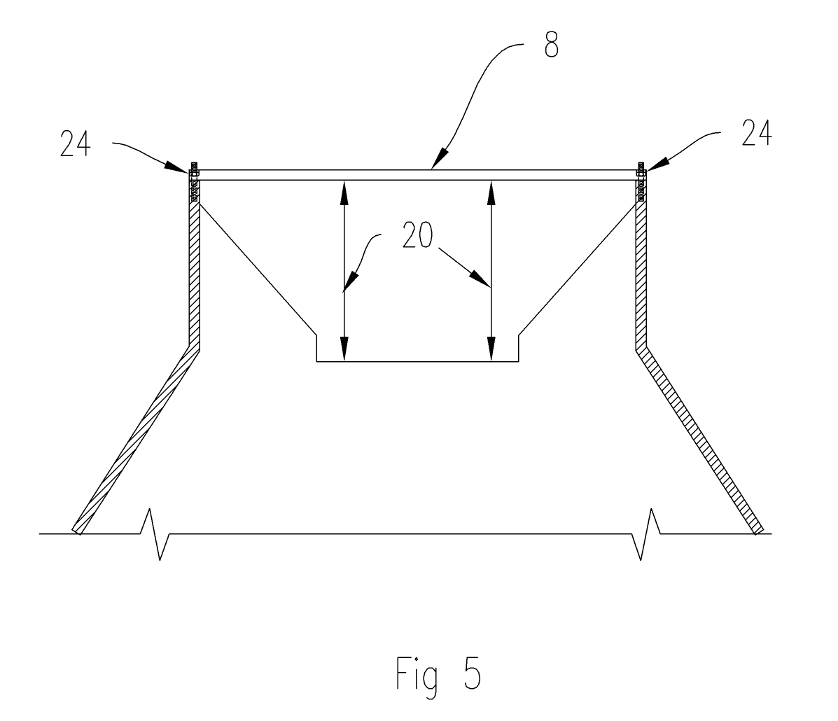

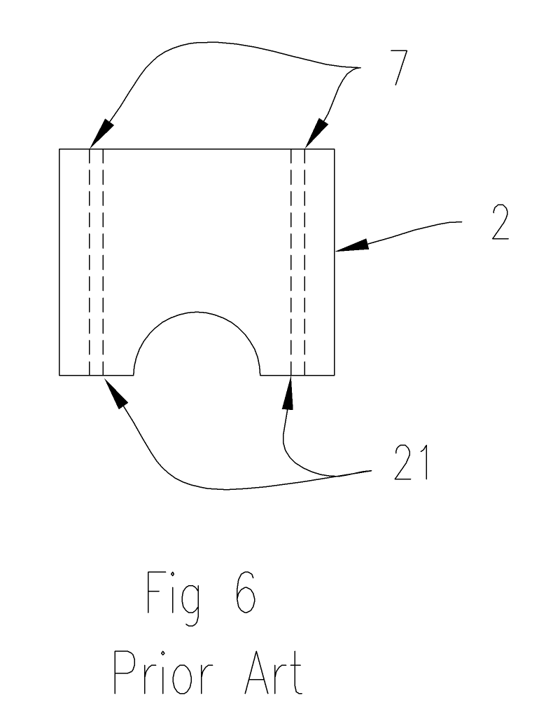

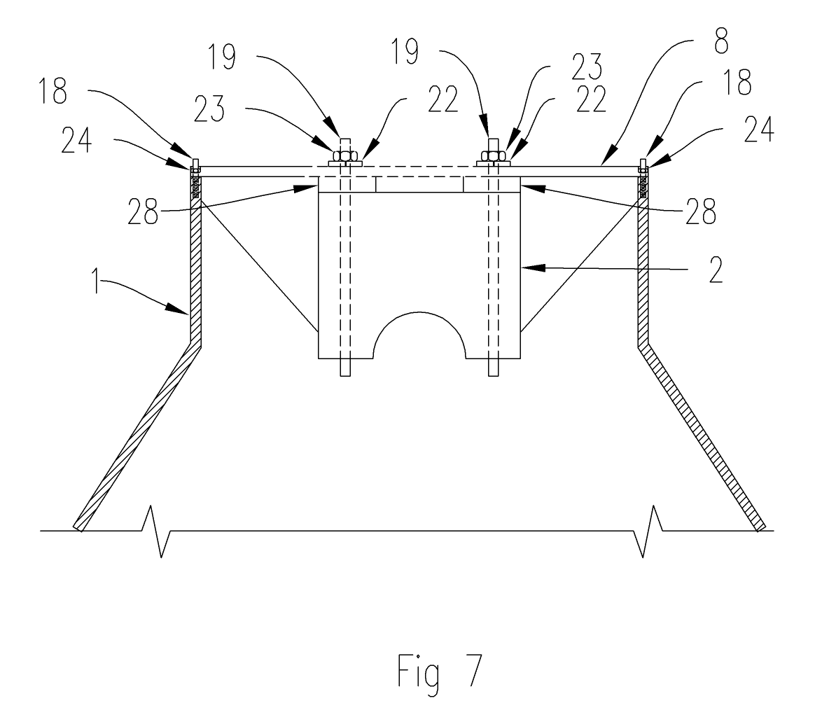

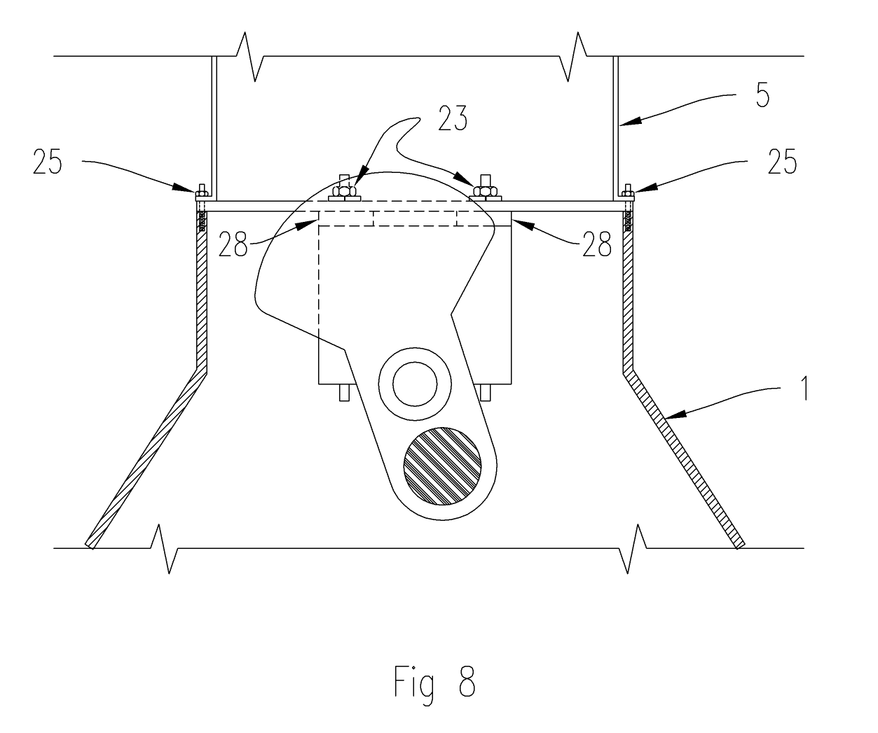

FIGS. 4 through 8 depict the plate 8 being installed onto the engine block 1. The procedure for installing the present plate 8 onto the engine block 1 is as follows:
1. Check the lower surface of the engine block skirt 4 for flatness, nicks, burrs, etc. and clean or correct as necessary.
2. Use two (2) 5/16-18 UNC nuts (not shown) tightened together onto a 5/16-18 UNC oil pan gasket stud 18 and then screw the stud 18 into the oil pan holes 17 (shown in FIG. 2) and remove the nuts. Repeat this procedure for all of the oil pan holes 17.
3. Install eight (8) main studs 19 for the #1, #2, #3 and #4 main bearing caps 2 using ARP assembly lubrication on the studs 19. The main bearing studs 19 are ½-13 UNC on the end that screws into the engine block 1 and ½-20 UNF for the end that will receive the washer and nut. The rear main bearing cap #5 should have the ARP assembly lubrication on the original bolts and then torque the original bolts and #5 main bearing cap into place prior to the plate 8 being installed as the #5 main bearing cap and bolts sit under the plate 8.
4. With the #1, #2, #3, and #4 main bearing caps 2 removed, secure the plate 8 to the engine block 1 with 5/16-18 UNC jam nuts 24. Then measure the distance (shown as line 20 in FIG. 5) from each of the main bearing cap landings to the lower surface of the engine block skirt 4. This measurement should be the same when checked side to side and front to back within ±0.010 inches. Take the average or arithmetic mean dimension of these measurements and subtract the thickness of the 1.00 inch diameter washer 28 (shown in FIG. 7). The result is the distance to be achieved, by machining the top of the main bearing cap 7, between the base mating surface 21, (shown in FIG. 6) of the main bearing cap 2 and the top bolting surface of the main bearing cap 7.
5. Remove the plate 8 from the engine block 1 and assemble the #1 through #4 main bearing caps 2 onto the main studs 19, place one 1.00 inch diameter spacer washer 28 on each main stud 19 on top of the main bearing caps 2, and then place the plate 1, without using an oil pan gasket, onto the main studs 19 and oil pan studs 18. Assemble the lock washers 22 and nuts 23 onto the main bearing cap studs 19. Assemble the 3/16 inch thick 5/16-18 UNC jam nuts 24 onto the oil pan studs 18 and down through the counter bores on the reinforcement plate 8. Hand snug the 5/16-18 UNC jam nuts 24 to the plate 8. Torque the 5/16-18 UNC jam nuts 24 accordingly. Torque the main stud nuts 23 per the ARP instruction sheet.
6. Assemble the oil pump with the oil pump shaft, bolts and lock washers (not shown).
7. Fill the counter bores around the oil pan studs 18 with a gasket sealer and assemble the oil pan gasket, more gasket sealer and the oil pan onto the 5/16-18 UNC oil pan studs 18. Assemble the sixteen (16) serrated flange nuts 25 on the oil pan studs 18 and the four (4) bolts with lock washers through the plate 8 and into the timing cover (not shown). Torque the flange nuts and bolts to Ford specifications.

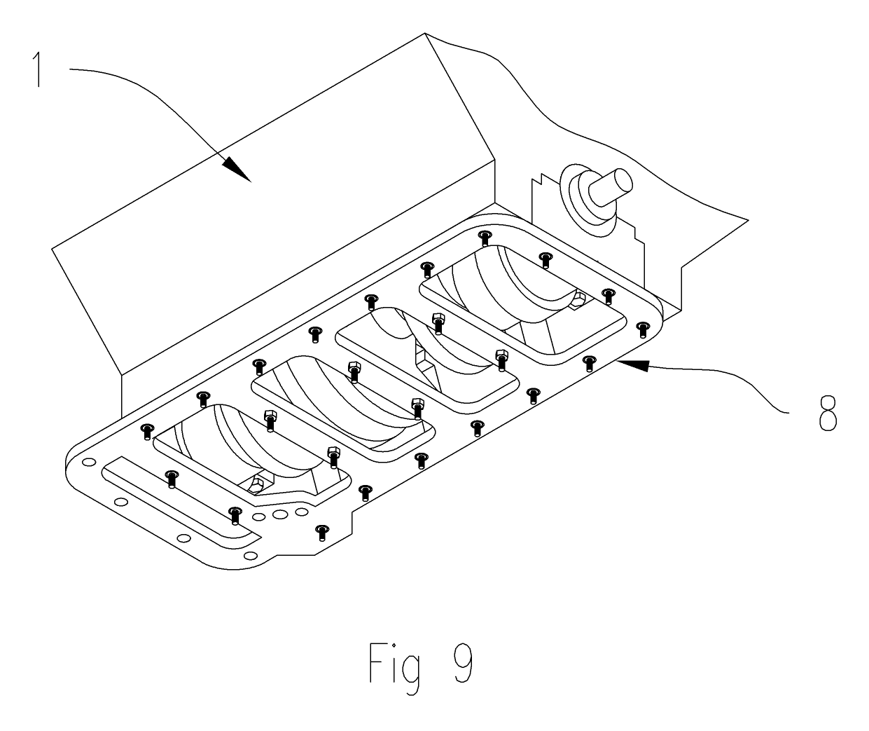

FIG. 9 depicts the plate 8 installed onto the engine block 1. This arrangement effectively ties the main bearing caps 2 to themselves and to the engine block 1 through the use of a ⅜ inch think high strength steel plate 1 substantially increasing the rigidity of the assembly thereby reducing vibration and elastic deformation of the main bearing caps 2 when the engine is in use.

The present reinforcement plate provides a much needed solution to the problem of engine flexure during high speed and high power operation. Modified internal combustion engines produce considerably more power than stock engines and as such produce greater internal stress and strain forces on the engine components. Of these forces, the main bearing caps probably absorb the greatest amount and as such, are subject to the greatest amount of elastic and plastic deformation of the materials. The present invention serves to ties 4 of the 5 main bearing caps and the engine block skirt rigidly together. The result is a much more rigid engine structure which has a greater resistance to material deformation, fatigue and strain, even at very high power outputs. This results in greater horsepower being available for power transmission rather than power being lost to deformation, vibration and fatigue.

It is to be understood that the present invention is not limited to the embodiments described above but encompasses any and all embodiments within the scope of the appended claims.

1. A structure of a cylinder block in an internal combustion engine comprising:
said cylinder block having five (5) bearing surfaces for supporting a crankshaft;
a lower skirt to said engine block;
a plurality of bearing caps for supporting said crankshaft mounted to said cylinder block bearing surfaces;
a generally rectangular shaped bearing cap support structure, said bearing cap support structure containing openings for the crankshaft counterweight and throws, oil pump shaft hole and oil pump mounting holes, counter-bored holes aligned with oil pan mounting holes and additional straight through holes aligned with the #1, #2, #3 and #4 main bearing cap mounting holes on said main bearing caps;
said bearing cap support structure being generally the same width of said engine block and longer than said engine block, said longer end protruding past the front end of said engine block;
said bearing cap support structure being removably attached to said lower skirt with threaded studs and locknuts, said locknuts residing in the counter-bored holes in said bearing cap support structure;
said bearing cap support structure being removably attached to said #1, #2, #3 and #4 bearing caps by a plurality of lock nuts and a plurality of second threaded studs, said second studs passing through said bearing cap support structure, a spacer washer, through said bearing caps and into said cylinder block main bearing cap threaded holes adjacent said cylinder block bearing surthees; and
straight through holes in said bearing cap support structure for removably attaching the said bearing cap support structure to the timing cover.

2. The support structure according to claim 1, wherein said support structure has a thickness of substantially three eights of an inch.

3. The support structure according to claim 1, wherein said support structure is formed of high strength steel.

4. The support structure according to claim 1, wherein each of said crankshaft counterweight and throw passages further includes internal stress relief radius at each internal and external corner thereof.

5. The support structure and internal combustion engine according to claim 1, wherein said engine has a V-8 configuration.

6-10. (canceled)

11. A means for strengthening and stiffening the main bearing caps of an internal combustion engine comprising;
a. a cylinder block having five (5) bearing surthees for supporting a crankshaft;
b. a lower skirt to said engine block;
c. a plurality of bearing caps for supporting said crankshaft mounted to said cylinder block bearing surfaces;
d. a generally rectangular shaped bearing cap support structure, said bearing cap support structure containing openings for the crankshaft counterweight and throws, oil pump shaft hole and oil pump mounting holes, counter-bored holes aligned with oil pan mounting holes and additional straight through holes aligned with the #1, #2, #3 and #4 main bearing cap mounting holes on said main bearing caps;
e. said bearing cap support structure being generally the same width of said engine block and longer than said engine block, said longer end protruding past the front end of said engine block;
f. a means for said bearing cap support structure to be removably attached to said lower skirt;
g. a means for said bearing cap support structure to be removably attached to said #1, #2, #3 and #4 bearing caps; and
h. a means in said bearing cap support structure for removably attaching said bearing cap support structure to the timing cover.

12. The means according to claim 11, wherein said support structure has a thickness of substantially three eights of an inch.

13. The means according to claim 11, wherein said support structure is formed of high strength steel.

14. The means according to claim 11, wherein each of said crankshaft counterweight and throw passages further includes an internal stress relief means at each internal and external corner thereof.

15. The means and internal combustion engine according to claim 11, wherein said engine has a V-8 configuration.
